(19) United States
(12) Patent Application Publication
(10) Pub. No.: US 2025/0201900 A1
(43) Pub. Date: Jun. 19, 2025

(54) Power Storage Device

(71) Applicant: TOYOTA JIDOSHA KABUSHIKI KAISHA, Toyota-shi Aichi-ken (JP)

(72) Inventors: Kazuhito KATO, Toyota-shi Aichi-ken (JP); Junta TAKASU, Nagoya-shi Aichi-ken (JP); Atsushi YAMANAKA, Nagoya-shi Aichi-ken (JP); Masato ONO, Nagoya-shi Aichi-ken (JP); Satoshi MORIYAMA, Nagoya-shi Aichi-ken (JP); Kosuke SUZUKI, Toyota-shi Aichi-ken (JP); Kazuki SUGIE, Miyoshi-shi Aichi-ken (JP); Kazuya KUMAZAWA, Nagoya-shi Aichi-ken (JP)

(73) Assignee: TOYOTA JIDOSHA KABUSHIKI KAISHA, Toyota-shi Aichi-ken (JP)

(21) Appl. No.: 18/976,820

(22) Filed: Dec. 11, 2024

(30) Foreign Application Priority Data
Dec. 15, 2023 (JP) 2023-212087

(51) Int. Cl. H01M 10/04; H01M 50/46; H01M 50/463; H01M 50/536

(52) U.S. Cl. CPC H01M 10/0431; H01M 10/0422; H01M 50/46; H01M 50/463; H01M 50/536

(57) ABSTRACT

A power storage device includes: a wound electrode assembly having a winding axis in a predetermined direction, and being formed of a stack wound spirally around the winding axis, the stack including positive and negative electrodes each in a strip shape, and a separator in a strip shape; and a case containing an electrolyte solution and the wound electrode assembly. The wound electrode assembly has an outer peripheral surface facing the case. Each of the positive and negative electrodes has a coated portion coated with an active material and an uncoated portion uncoated with the active material. In the wound electrode assembly, the uncoated portion forms a recessed portion recessed from the outer peripheral surface toward the winding axis, and at least one of the negative and positive electrodes, and the separator is folded to form a thickened portion in the stack to fill the recessed portion.

### CROSS REFERENCE TO RELATED APPLICATIONS

This nonprovisional application is based on Japanese Patent Application No. 2023-212087 filed on Dec. 15, 2023 with the Japan Patent Office, the entire contents of which are hereby incorporated by reference.

### BACKGROUND

### Field

The present disclosure relates to a power storage device.

### Description of the Background Art

Conventionally, as disclosed in Japanese Patent Laying-Open No. 4-206341, there is known a battery including a wound electrode assembly configured by spirally winding first and second strip-shaped electrodes, each having a strip-shaped current collector and an electrode mixture formed on both surfaces thereof, in a state of being stacked with a strip-shaped separator interposed therebetween, along a length direction thereof.

### SUMMARY

A wound electrode assembly has an uncoated portion to which no active material is applied, at its winding start portion and/or winding end portion. Further, in order to attach a tab or improve liquid injection, an uncoated portion may be provided between a coated portion and another coated portion. Such an uncoated portion may form a recessed portion in the outer peripheral surface of the wound electrode assembly. When the wound electrode assembly having the recessed portion formed in the outer peripheral surface is contained in a case, a local load may be applied to the wound electrode assembly.

The present disclosure provides a power storage device that enables reduction of a local load applied to a wound electrode assembly.

According to an aspect of the present disclosure, a power storage device includes: a wound electrode assembly with a winding axis extending in a predetermined direction, the wound electrode assembly being formed of a stack wound spirally around the winding axis, the stack including a positive electrode in a strip shape, a negative electrode in a strip shape, and a separator in a strip shape; and a case containing an electrolyte solution and the wound electrode assembly. The wound electrode assembly has an outer peripheral surface facing the case. Each of the positive electrode and the negative electrode has a coated portion coated with an active material and an uncoated portion uncoated with the active material. In the wound electrode assembly, the uncoated portion forms a recessed portion recessed from the outer peripheral surface toward the winding axis. In the wound electrode assembly, at least one of the negative electrode, the positive electrode, and the separator of the outer peripheral surface is folded to form a thickened portion in the stack. The thickened portion is located to fill the recessed portion.

With the above-described configuration, the thickened portion formed of at least one of the positive electrode, the negative electrode, and the separator can fill the recessed portion formed due to the uncoated portion. Thus, the outer peripheral surface of the wound electrode assembly can made less uneven. Accordingly, application of a local load to the wound electrode assembly can be reduced, as compared with a configuration having no thickened portion.

In some embodiments, the separator is longer in a length around the winding axis than the negative electrode and the positive electrode. The thickened portion is formed of only the separator, among the positive electrode, the negative electrode, and the separator. With the above-described configuration, the thickened portion can be formed of the separator only.

In some embodiments, the uncoated portion extends in the predetermined direction. The thickened portion is formed of the separator letter-folded so as to be received in the recessed portion, in a circumferential direction of the outer peripheral surface.

With the above-described configuration, the outer peripheral surface of the wound electrode assembly can be made further less uneven.

In some embodiments, the thickened portion is welded to the recessed portion.

With the above-described configuration, the thickened portion can be fixed. Therefore, as compared with a configuration in which the thickened portion is not fixed, it is possible to further reduce a local load applied to the wound electrode assembly.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a cross-sectional view of a power storage device.

FIG. 2 is a perspective view of a wound electrode assembly.

FIG. 3 is a diagram for explaining a coated portion and an uncoated portion.

FIG. 4 is a diagram for explaining a layer configuration of a wound electrode assembly.

FIG. 5 is a state transition diagram for explaining a part of a manufacturing process of the wound electrode assembly.

### DESCRIPTION OF THE EMBODIMENTS

Hereinafter, embodiments of the present disclosure will be described with reference to the drawings. In the following description, the same members are denoted by the same reference numerals. Their names and functions are also the same. Therefore, detailed description thereof will not be repeated.

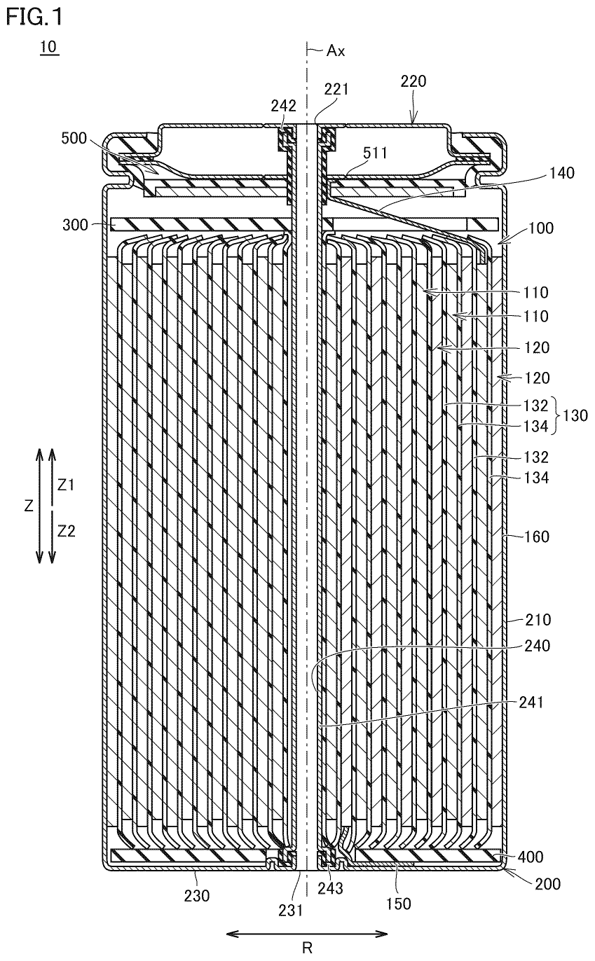

FIG. 1 is a cross-sectional view of a power storage device. As shown in FIG. 1, the power storage device 10 includes a wound electrode assembly 100 and a case 200. The wound electrode assembly 100 includes a strip-shaped positive electrode 110, a strip-shaped negative electrode 120, a strip-shaped separator 130, a positive electrode tab lead 140, and a negative electrode tab lead 150.

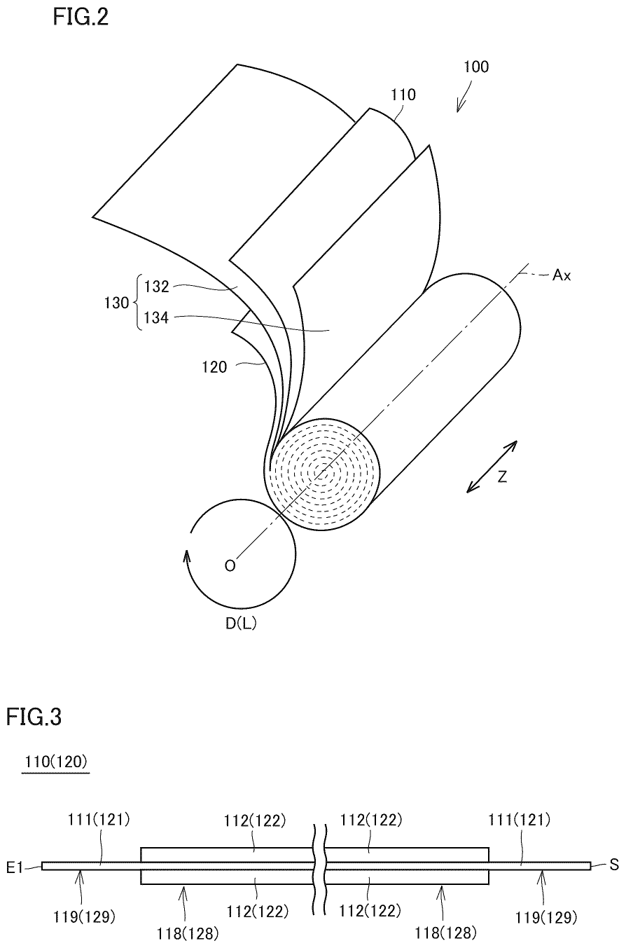

FIG. 2 is a perspective view of the wound electrode assembly 100. As shown in FIG. 2, the wound electrode assembly 100 has a winding axis Ax extending in the Z direction (predetermined direction). The wound electrode assembly 100 is configured by spirally winding a stack including a strip-shaped positive electrode 110, a strip-shaped negative electrode 120, and a strip-shaped separator 130 around the winding axis Ax. Specifically, the separator 130 includes a first separator 132 and a second separator 134. In the stack, the negative electrode 120, the first separator 132, the positive electrode 110, and the second separator 134 are stacked in this order. The stack is wound in the direction of arrow D in FIG. 3 (corresponding to the longitudinal direction L of the stack).

Referring back to FIG. 1, the wound electrode assembly 100 includes an outer peripheral surface 160 facing the case 200. The separator 130 is provided between the positive electrode 110 and the negative electrode 120. The separator 130 separates positive electrode 110 and negative electrode 120 while allowing ions (e.g., lithium ions) to move between positive electrode 110 and negative electrode 120. As described above, the separator 130 includes the first separator 132 and the second separator 134.

The positive electrode 110 includes a positive electrode current collector foil and a positive electrode active material layer. The positive electrode active material layer is applied to a part of the positive electrode current collector foil. As described above, the positive electrode 110 includes the coated portion coated with the positive electrode active material and the uncoated portion uncoated with the positive electrode active material layer.

As the positive electrode current collector foil, for example, aluminum or the like is used. The positive electrode active material layer is formed by applying a positive electrode slurry to the surface of the positive electrode current collector foil and drying the positive electrode slurry. The positive electrode active material layer is in close contact with the separator 130.

The negative electrode 120 includes a negative electrode current collector foil and a negative electrode active material layer. The negative electrode active material layer is applied to a part of the negative electrode current collector foil. As described above, the negative electrode 120 includes the coated portion uncoated with the negative electrode active material and the uncoated portion not coated with the negative electrode active material. The coated portion and the uncoated portion will be described later (FIG. 3).

As the negative electrode current collector foil, for example, a copper foil or the like is used. The negative electrode active material layer is formed by applying a negative electrode slurry to the surface of the negative electrode current collector foil and drying the negative electrode slurry. The negative electrode active material layer is in close contact with the separator 130.

The positive electrode tab lead 140 is provided so as to protrude from the positive electrode current collector foil of the positive electrode 110 toward one direction side (direction side of Z1) in the axial direction Z. The negative electrode tab lead 150 is provided so as to protrude from the negative electrode current collector foil of the negative electrode 120 toward the other direction side (direction side of Z2) in the axial direction Z.

The case 200 contains the wound electrode assembly 100 and the electrolyte solution. The case 200 is also referred to as a “cell case”. The case 200 has an outer peripheral surface 210, a first end 220, a second end 230, and an inner peripheral surface 240.

The outer peripheral surface 210 is cylindrical and is disposed on the outer side in the radial direction R of the wound electrode assembly 100. The outer peripheral surface 210 is formed of copper, aluminum, or the like. The outer peripheral surface 210 is in contact with the negative electrode current collector foil of the negative electrode 120 provided on the outermost periphery of the wound electrode assembly 100.

The inner peripheral surface 240 extends from the first hole portion 221 to the second hole portion 231. The inner peripheral surface 240 is disposed on the inner side in the radial direction R of the wound electrode assembly 100. The inner peripheral surface 240 has a core portion 241, a first insulating end portion 242, and a second insulating end portion 243.

The core portion 241 has a cylindrical outer shape. The core portion 241 is disposed on the inner side in the radial direction R of the wound electrode assembly 100. In some embodiments, the core portion 241 is formed of a metal such as copper or aluminum from the viewpoint of heat dissipation.

The power storage device 10 further includes a positive-side insulating plate 300, a negative-side insulating plate 400, and CID (Current Interrupt Device) 500 having a surface 511. The positive-side insulating plate 300 and the negative-side insulating plate 400 are housed in the case 200.

FIG. 3 is a diagram for explaining a coated portion and an uncoated portion. FIG. 3 is a state of the positive electrode 110 before the stack is wound. As shown in FIG. 3, the end portion S is the winding start side. The end portion E1 is the winding end side. In FIG. 3, the longitudinal direction of the positive electrode 110 is the left-right (lateral) direction. The direction of the shorter side of the positive electrode 110 is not shown. The thickness direction of the positive electrode 110 is the top-bottom (vertical) direction.

The positive electrode 110 includes a positive electrode current collector foil 111 and a positive electrode active material layer 112. The positive electrode active material layer 112 is provided on both surfaces of the positive electrode current collector foil 111. The positive electrode active material layer 112 on one surface side and the positive electrode active material layer 112 on the other surface side are provided at positions symmetrical with respect to the positive electrode current collector foil 111.

Specifically, the positive electrode current collector foil 111 includes a coated portion 118 coated with the positive electrode active material forming the positive electrode active material layer 112, and an uncoated portion 119 not coated with the positive electrode active material. In this example, uncoated portions 119 are present at both ends of the positive electrode 110 in the longitudinal direction. In order to connect the positive electrode tab lead 140 to the positive electrode current collector foil 111, a portion of the positive electrode 110 in the longitudinal direction is an uncoated portion (not shown).

Similarly, the negative electrode 120 includes a negative electrode current collector foil 121 and a negative electrode active material layer 122. The negative electrode active material layer 122 is provided on both surfaces of the negative electrode current collector foil 121. The negative electrode active material layer 122 on one surface side and the negative electrode active material layer 122 on the other surface side are provided at positions symmetrical with respect to the negative electrode current collector foil 121.

Specifically, the negative electrode current collector foil 121 includes a coated portion 128 coated with the negative electrode active material forming the negative electrode active material layer 122 and an uncoated portion 129 not coated with the negative electrode active material. In this example, uncoated portions 129 are present at both ends of the negative electrode 120 in the longitudinal direction. In order to connect the negative electrode tab lead 150 to the negative electrode current collector foil 121, a portion of the negative electrode 120 in the longitudinal direction is an uncoated portion (not shown).

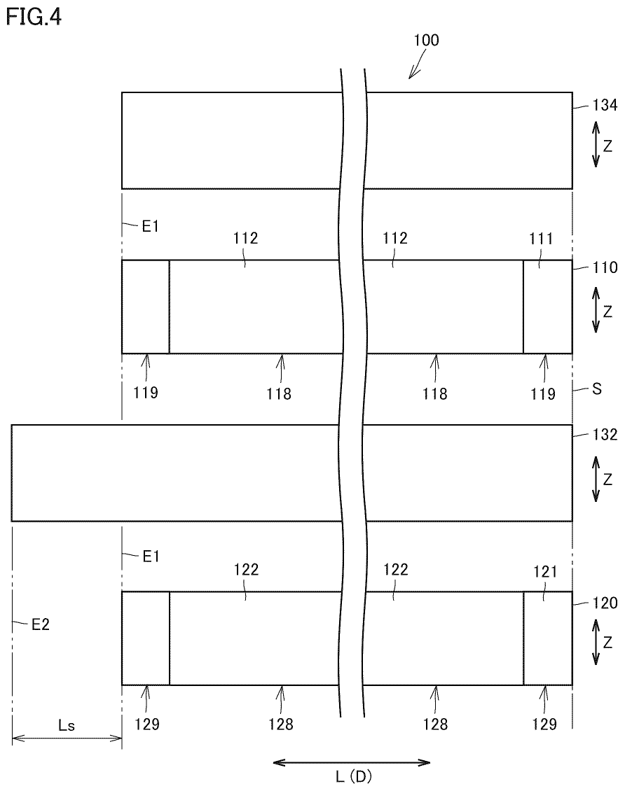

FIG. 4 is a diagram for explaining a layer configuration of the wound electrode assembly 100. As described above, the wound electrode assembly 100 is configured by spirally winding a stack in which the negative electrode 120, the first separator 132, the positive electrode 110, and the second separator 134 are stacked in this order around the winding axis Ax.

As shown in FIG. 4, the end portion S is the winding start side of the negative electrode 120, the positive electrode 110, and the first and second separators 132 and 134. The end portion E1 is the winding end side of the negative electrode 120, the positive electrode 110, and the second separator 134. The end portion E2 is the winding end side of the first separator 132.

In this example, the length of the first separator 132 in the longitudinal direction (L direction) is longer than the length of the negative electrode 120 in the longitudinal direction, the length of the second separator 134 in the longitudinal direction, and the length of the positive electrode 110 in the longitudinal direction. Specifically, the length of the first separator 132 around the winding axis Ax is longer than those of the positive electrode 110, the negative electrode 120, and the second separator 134. The first separator 132 is longer than the positive electrode 110, the negative electrode 120, and the second separator 134 by a distance Ls in the longitudinal direction.

The present disclosure is not limited to the above, and the lengths of the first and second separators 132 and 134 around the winding axis Ax may be longer than the length of the negative electrode 120 around the winding axis Ax and the length of the positive electrode 110 around the winding axis Ax. The length of the negative electrode 120 around the winding axis Ax may be longer than the length of the first and second separators 132 and 134 around the winding axis Ax and the length of the positive electrode 110 around the winding axis Ax. Furthermore, the length of the positive electrode 110 around the winding axis Ax may be longer than the length of the first and second separators 132 and 134 around the winding axis Ax and the length of the negative electrode 120 around the winding axis Ax.

The uncoated portion 119 of the positive electrode 110 and the uncoated portion 129 of the negative electrode 120 extend in the Z direction (winding axis Ax direction) in FIG. 1. Specifically, the uncoated portion 119 of the positive electrode 110 is formed up to both ends of the positive electrode 110 in the shorter-side direction. Similarly, the uncoated portion 129 of the negative electrode 120 is formed up to both ends of the negative electrode 120 in the shorter-side direction.

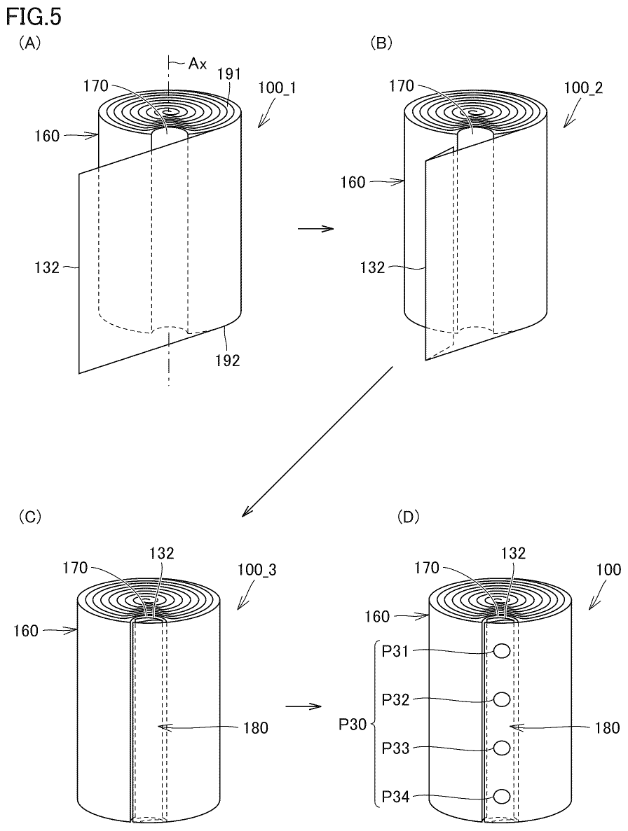

FIG. 5 is a state transition diagram for explaining a part of the manufacturing process of the wound electrode assembly 100. As shown in a state (A) of FIG. 5, the first intermediate body 100_1 of the wound electrode assembly 100 is produced by winding the above-described stack around the winding axis Ax. At the stage where the first intermediate body 100_1 is produced by winding the stack around the winding axis Ax in this manner, a recessed portion 170 recessed from the outer peripheral surface 160 side toward the winding axis Ax side is formed in the first intermediate body 100_1 by the uncoated portions 119 and 129. Specifically, as shown in FIG. 3, since the thickness of the uncoated portions 119 and 129 is smaller than the thickness of the coated portions 118 and 128, the recessed portion 170 is formed in the first intermediate body 100_1. In this example, the uncoated portion 119 of the positive electrode 110 and the uncoated portion 129 of the negative electrode 120 at least partially overlap each other in the direction from the recessed portion 170 toward the winding axis Ax.

In the first intermediate body 100_1, the recessed portion 170 extends from an upper end portion 191 on the positive side insulating plate 300 (see FIG. 1) side to a lower end portion 192 on the negative side insulating plate 400 side. In the present example, in a side view of the wound electrode assembly 100, the recessed portion 170 has a rectangular shape whose longer side is parallel to the winding axis Ax.

As described with reference to FIG. 4, the length of the first separator 132 in the longitudinal direction is longer than the length of the negative electrode 120 in the longitudinal direction, the length of the first separator 132 in the longitudinal direction, and the length of the positive electrode 110 in the longitudinal direction. Therefore, in the first intermediate body 100_1, of the negative electrode 120, the positive electrode 110, and the first and second separators 132 and 134, only the rear end side (winding end side) of the first separator 132 is left unwound.

After the first intermediate body 100_1 is produced, as shown in the state (B), the rear end side of the first separator 132 is folded. As a result, the second intermediate body 100_2 is generated. In this example, the rear end side of the first separator 132 is folded inward. Specifically, the first separator 132 is mountain-folded at a fold line parallel to the winding axis Ax.

After the second intermediate body 100_2 is produced, the rear end side of the first separator 132 is further folded. In this example, the rear end side of the first separator 132 is further folded inward. Specifically, the first separator 132 is further mountain-folded at a fold line parallel to the winding axis Ax. More specifically, the first separator 132 is letter-folded so as to be received in the recessed portion 170, in the circumferential direction of the outer peripheral surface 160.

By letter-folding the first separator 132, a thickened portion 180 is formed in the wound stack. In this example, the first separator 132 is folded twice to form the thickened portion 180 in the stack. For simplicity of description, it is folded twice, but the number of times it is folded may be one or three or more. The number of times it is folded may be determined by the length of the first separator 132 and the length of the recessed portion 170 in the outer circumferential direction.

As shown in the state (C), the third intermediate body 100_3 is formed by receiving the thickened portion 180 in the recessed portion 170. Next, in the state of the third intermediate body 100_3, the thickened portion 180 is welded to the recessed portion 170. By applying heat to the region P30 of the thickened portion 180, the thickened portion 180 is welded to the recessed portion 170. In this example, as shown in the state (D), heat is applied to a plurality of regions P31, P32, P33, and P34 arranged in the vertical direction among the surface regions facing the outer periphery in the thickened portion 180.

By the above process, the wound electrode assembly 100 in which the thickened portion 180 is provided at a position corresponding to the recessed portion 170 is produced. The thickened portion 180 is located to fill the recessed portion 170. In some embodiments, the entire recessed portion 170 is filled with the thickened portion 180. However, the present disclosure is not limited thereto, and at least a part of the recessed portion 170 may be filled.

As described above, by applying heat only to the plurality of regions P31, P32, P33, and P34, the thickened portion 180 is partially thermally welded to the recessed portion 170. Therefore, it is possible to allow the electrolyte solution to permeate into the wound electrode assembly 100 from a portion where the electrolyte solution is not welded. Therefore, the electrolyte solution easily penetrates into the wound electrode assembly 100 as compared with the case where the thickened portion 180 is entirely thermally welded to the recessed portion 170.

In the above description, the case where the first separator 132 is mountain-folded at the fold line parallel to the winding axis Ax has been described as an example, but the present disclosure is not limited thereto. The first separator 132 may be valley-folded at a fold line parallel to the winding axis Ax. The first separator 132 may be zig-zag-folded along a fold line parallel to the winding axis Ax.

### Aspects

(1) As described above, the power storage device 10 includes the wound electrode assembly 100 and the case 200 that contains an electrolyte solution and the wound electrode assembly 100. The wound electrode assembly 100 has the winding axis Ax extending in the Z direction, and is configured by spirally winding a stack including the strip-shaped positive electrode 110, the strip-shaped negative electrode 120, and the strip-shaped separator 130 around the winding axis Ax.

The wound electrode assembly 100 includes the outer peripheral surface 160 facing the case 200. The positive electrode 110 and the negative electrode 120 respectively include coated portions 118 and 128 coated with an active material and uncoated portions 119 and 129 not coated with the active material.

In the wound electrode assembly 100, the uncoated portions 119 and 129 form the recessed portion 170 recessed from the outer peripheral surface 160 toward the winding axis Ax. In the wound electrode assembly 100, the separator 130 (in this example, the first separator 132) is folded on the outer peripheral surface 160 side to form the thickened portion 180 in the stack. The thickened portion 180 is located to fill the recessed portion 170.

According to such a configuration, the recessed portion 170 formed due to the uncoated portions 119 and 129 can be filled with the thickened portion 180 formed of the separator 130. Therefore, the outer peripheral surface 160 of the wound electrode assembly 100 can be made less uneven. As a result, it is possible to reduce the local load applied to the wound electrode assembly 100 as compared with a configuration in which the thickened portion 180 is not provided.

The separator 130 is thin and difficult to have an adequate welding strength. However, by folding the separator 130 as described above, it is possible to obtain a good bonding strength of the thickened portion 180 to the recessed portion 170.

The thickened portion 180 may be formed by folding at least one of the first separator 132 and the second separator 134 constituting the separator 130. Furthermore, the present disclosure is not limited to the above, and the thickened portion 180 may be formed by folding at least one of the positive electrode 110, the negative electrode 120, and the separator 130. For example, the thickened portion 180 may be formed by folding only the positive electrode 110, among the positive electrode 110, the negative electrode 120, and the separator 130. The thickened portion 180 may be formed by folding only the negative electrode 120. The thickened portion 180 may be formed by folding the positive electrode 110, the negative electrode 120, and the separator 130. When the thickened portion 180 is formed by folding the positive electrode 110, the negative electrode 120, and the separator 130, the lengths of the positive electrode 110, the negative electrode 120, and the separator 130 (specifically, the first and second separators 132 and 134) in the longitudinal direction may be substantially the same as those in FIG. 4. Even in such a case, it is possible to reduce the local load applied to the wound electrode assembly 100 in the same manner as described above.
(2) As shown in FIG. 4, the separator 130 has a longer length around the winding axis Ax than the negative electrode 120 and the positive electrode 110. Therefore, the thickened portion 180 can be formed of only the separator 130.
(3) As shown in FIG. 4, the uncoated portions 119 and 129 extend in the Z direction. As shown in FIG. 5, the thickened portion 180 is formed by letter-folding the separator 130 so as to be received in the recessed portion 170, in the circumferential direction of the outer peripheral surface 160. According to such a configuration, the outer peripheral surface 160 of the wound electrode assembly 100 can be made less uneven.
(4) As shown in the state (D) of FIG. 5, the thickened portion 180 is welded to the recessed portion 170. According to such a configuration, the thickened portion 180 can be fixed. Therefore, it is not necessary to fix the thickened portion 180 to the outer peripheral surface 160 using a tape.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage device comprising:
a wound electrode assembly with a winding axis extending in a predetermined direction, the wound electrode assembly being formed of a stack wound spirally around the winding axis, the stack including a positive electrode in a strip shape, a negative electrode in a strip shape, and a separator in a strip shape; and
a case containing an electrolyte solution and the wound electrode assembly, wherein
the wound electrode assembly has an outer peripheral surface facing the case,
each of the positive electrode and the negative electrode has a coated portion coated with an active material and an uncoated portion uncoated with the active material,
in the wound electrode assembly,
the uncoated portion forms a recessed portion recessed from the outer peripheral surface toward the winding axis, and
at least one of the negative electrode, the positive electrode, and the separator of the outer peripheral surface is folded to form a thickened portion in the stack, and
the thickened portion is located to fill the recessed portion.

2. The power storage device according to claim 1, wherein
the separator is longer in a length around the winding axis than the negative electrode and the positive electrode, and
the thickened portion is formed of only the separator, among the positive electrode, the negative electrode, and the separator.

3. The power storage device according to claim 2, wherein
the uncoated portion extends in the predetermined direction, and
the thickened portion is formed of the separator letter-folded so as to be received in the recessed portion, in a circumferential direction of the outer peripheral surface.

4. The power storage device according to claim 1, wherein the thickened portion is welded to the recessed portion.
